(19) United States
(12) Patent Application Publication
(10) Pub. No.: US 2022/0148134 A1
(43) Pub. Date: May 12, 2022

(54) SYSTEMS AND METHOD FOR PROVIDING IMAGES ON VARIOUS RESOLUTION MONITORS

(71) Applicant: Embarcadero Technologies, Inc., Austin, TX (US)

(72) Inventors: Marco Cantu, Piacenza (IT); Sarina DuPont, Palm Beach Gardens, FL (US); Alexey Sharagin, Ulan-Ude (RU)

(21) Appl. No.: 17/507,705

(22) Filed: Oct. 21, 2021

Related U.S. Application Data
(60) Provisional application No. 63/112,025, filed on Nov. 10, 2020.

(51) Int. Cl. G06T 3/40; G06T 9/00

(52) U.S. Cl. CPC G06T 3/4092; G06T 9/00

(57) ABSTRACT

Methods are described herein for determining a resolution indication for a resolution of a display device, determining a closest stored bitmap from a plurality of stored bitmaps according to the resolution indication, where each of the plurality of stored bitmaps are named according to a naming convention, the naming convention associating a name of one of the plurality of stored bitmaps and a resolution representation of the one of the plurality of stored bitmaps to the one of the plurality of stored bitmaps, the plurality of stored bitmaps being components for controls, each of the components for controls including one or more graphical elements, and, displaying a digital image corresponding to the closest stored bitmap.

### CROSS-REFERENCE TO RELATED APPLICATIONS AND CLAIM OF PRIORITY

This application claims the benefit of U.S. Provisional Application No. 63/112,025, filed Nov. 10, 2020, the content of which are fully incorporated herein by reference in its entirety.

### BACKGROUND

A monitor can be used to display digital information. The clarity and precision of the displayed images on the monitor may be scaled up and/or scaled down by adjusting the resolution of the monitor. The resolution of the monitor may be the number of picture elements (e.g., “pixels”) that can be displayed on the monitor, where a pixel is simply the smallest visual point on the display. The number of pixels that can be displayed on the monitor may be quantified by the pixel density, or pixels-per-inch (“PPI”). Similarly, dots-per-inch (“DPI”) quantifies the number of dots that can be displayed on a monitor and/or a piece of paper in an inch. The pixel density may be determined by dividing the screen resolution (e.g., width×height of the screen in pixels) by the size of the screen in one direction (e.g., width or height of the screen in inches). The width of the screen in pixels can be considered a horizontal line of pixels. The height of the screen can be considered a vertical line of pixels. Screens with higher resolutions (have a higher number of pixels) may have more clear and precise digital images because more digital information is able to be displayed.

In the current market, users employ a broad range of different monitors and/or screens with various resolutions. There is a need to build user interfaces that scale accurately across various monitors and/or screens of different devices or of the same device. For example, user interfaces displayed across various monitors and/or screens of multiple computers should visually appear the same such that users viewing user interfaces have consistent viewing experiences. Further, user interfaces displayed across various monitors and/or screens of a single computer should visually appear the same such that the same user viewing the user interfaces has consistent viewing experiences across the monitors.

### SUMMARY

The example arrangements disclosed herein are directed to solving the issues relating to one or more of the problems presented in conventional resolution scaling, as well as providing additional features that will become readily apparent by reference to the following detailed description when taken in conjunction with the accompanying drawings. In accordance with various arrangements, example methods and computer program products are disclosed herein. It is understood however, that these arrangements are presented by way of example and are not limited, and it will be apparent to those of ordinary skill in the art who read the present disclosure that various modifications to the disclosed arrangements can be made while remaining within the scope of this disclosure.

In some arrangements, a method of determining a resolution indication for a resolution of a display device, includes determining a closest stored bitmap from a plurality of stored bitmaps according to the resolution indication, where each of the plurality of stored bitmaps are named according to a naming convention, the naming convention associating a name of one of the plurality of stored bitmaps and a resolution representation of the one of the plurality of stored bitmaps to the one of the plurality of stored bitmaps, the plurality of stored bitmaps being components for controls, each of the components for controls including one or more graphical elements, and, displaying a digital image corresponding to the closest stored bitmap.

Particular examples relates to a method of creating a consistent application user experience, including determining a resolution indication for a resolution of a display device, and determining a closest stored bitmap from a plurality of stored bitmaps according to the resolution indication, wherein each of the plurality of stored bitmaps are named according to a naming convention, the naming convention associating a name of one of the plurality of stored bitmaps and a resolution representation value of the one of the plurality of stored bitmaps to the one of the plurality of stored bitmaps, the plurality of stored bitmaps being one or more components for controls, each of the one or more components for controls including one or more graphical elements. The method further includes displaying a digital image corresponding to the closest stored bitmap.

In further examples, the resolution indication is based on a message from an operating system.

In further examples, the resolution indication is determined based on a user command.

In further examples, determining the closest stored bitmap includes determining a resolution representation of the resolution indication, and determining the closest stored bitmap based on the resolution representation of the resolution indication and the plurality of stored bitmaps, the closest stored bitmap determined by comparing the resolution representation of the resolution indication to the resolution representation of each of the plurality of stored bitmaps, and selecting the closest stored bitmap based on a smallest difference between the resolution representation of the one of the plurality of stored bitmaps and the resolution representation of the resolution indication.

In further examples, the determined closest stored bitmap is a custom bitmap named according to the naming convention, the naming convention associating a name of the custom bitmap and a resolution representation of the custom bitmap to the custom bitmap.

In further examples, the determined closest stored bitmap is a bitmap created in an application toolkit named according to the naming convention, the naming convention associating a name of the bitmap created in the application toolkit and a resolution representation of the bitmap created in the application toolkit to the bitmap created in the application toolkit.

In further examples, the plurality of stored bitmaps are stored in a user interface component library, the user interface component library being a component library in a development environment for developing a plurality of applications.

In further examples, the resolution indication is based on a scaling factor.

In further examples, the scaling factor is based on a ratio of one or more pixel densities and a desired one or more pixel densities.

Further examples relate to a non-transitory processor-readable medium having processor-readable instructions, when executed, cause a processor to: determine a resolution indication for a resolution of a display device; determine a closest stored bitmap from a plurality of stored bitmaps according to the resolution indication, wherein each of the plurality of stored bitmaps are named according to a naming convention, the naming convention associating a name of one of the plurality of stored bitmaps and a resolution representation value of the one of the plurality of stored bitmaps to the one of the plurality of stored bitmaps, the plurality of stored bitmaps being components for controls, each of the components for controls including one or more graphical elements; and display a digital image corresponding to the closest stored bitmap.

In further examples of the non-transitory processor-readable medium, the resolution indication is based on a message from an operating system.

In further examples of the non-transitory processor-readable medium, the resolution indication is determined based on a user command.

In further examples of the non-transitory processor-readable medium, determining the closest stored bitmap includes: determining a resolution representation of the resolution indication; and determining the closest stored bitmap based on the resolution representation of the resolution indication and the plurality of stored bitmaps, the closest stored bitmap determined by comparing the resolution representation of the resolution indication to the resolution representation of each of the plurality of stored bitmaps, and selecting the closest stored bitmap based on a smallest difference between the resolution representation of the one of the plurality of stored bitmaps and the resolution representation of the resolution indication.

In further examples of the non-transitory processor-readable medium, the determined closest stored bitmap is a custom bitmap named according to the naming convention, the naming convention associating a name of the custom bitmap and a resolution representation of the custom bitmap to the custom bitmap.

In further examples of the non-transitory processor-readable medium, the determined closest stored bitmap is a bitmap created in an application toolkit named according to the naming convention, the naming convention associating a name of the bitmap created in the application toolkit and a resolution representation of the bitmap created in the application toolkit to the bitmap created in the application toolkit.

In further examples of the non-transitory processor-readable medium, the plurality of stored bitmaps are stored in a user interface component library, the user interface component library being a component library in a development environment for developing a plurality of applications.

In further examples of the non-transitory processor-readable medium, the resolution indication is based on a scaling factor.

In further examples of the non-transitory processor-readable medium, the scaling factor is based on a ratio of one or more pixel densities and a desired one or more pixel densities.

The above and other aspects and their implementations are described in greater detail in the drawings, the descriptions, and the claims.

### BRIEF DESCRIPTION OF THE DRAWINGS

The accompanying drawings, which are incorporated herein and constitute part of this specification, illustrate exemplary arrangements of the disclosure, and together with the general description given above and the detailed description given below, serve to explain the features of the various arrangements.

FIG. 1 is a schematic block diagram of a computing device that is capable of employing a toolkit to develop applications, according to some arrangements.

FIG. 2 is a schematic diagram of a computer system running an application that selects and displays bitmaps according to screen resolution, according to some arrangements.

FIG. 3 is a schematic diagram showing an example system selecting a bitmap out of a collection of bitmaps, according to some arrangements.

FIG. 4 is a generalized diagram representing a storage system in an application, according to some arrangements.

FIG. 5 is a flow chart of a method of creating a consistent user experience, according to some arrangements.

FIG. 6 is a flow chart of a method of determining the closest stored bitmap, according to some arrangements.

FIG. 7 is an example of scaled pixels according to a scale factor, according to some arrangements.

### DETAILED DESCRIPTION

Various arrangements will be described in detail with reference to the accompanying drawings. Wherever possible, the same reference numbers can be used throughout the drawings to refer to the same or like parts. Different reference numbers can be used to refer to different, same, or similar parts. References made to particular arrangements and implementations are for illustrative purposes, and are not intended to limit the scope of the disclosure or the claims.

A high resolution screen allows for increased digital image clarity on the screen. Accordingly, in many contexts, higher resolution screens are preferred. However, when displayed on a high resolution screen, a low quality digital image (e.g., an image that does not utilize enough pixels to clearly display the content of the image) may look visibly out of place. A low quality image may look visibly out of place because the image appears blurry. The image may appear blurry because the image may be stretched, making the stretched pixels visually appear larger.

Also, high resolution screens can be costly. Accordingly, lower resolution screens are used in certain contexts because they are less expensive, and some users may not have a need to display crisp and precise images. However, providing a lower resolution screen a high resolution image can cause the image to be distorted through errors caused by stretching the image incorrectly. Additionally, forcing screens to display high density pixel images (e.g., by not providing other resolution images) may affect the speed of the processors facilitating the display.

Generally, various applications are designed by developers to display information (e.g., on screens, monitors, and the like) and perform various functions. In certain examples, when an application is initiated, the application's main window is created and displayed. This window may be the primary interface between the user and the application. There may also be subsequent windows created by the application to support the application's ability to display text and/or images to a user and allow the user to navigate the application. Images, graphics, icons, elements and the like may be created based on a bitmap, which is a spatially mapped array of bits used to create digital images, graphics, icons, elements and the like. Digital images created by bitmaps may include, but are not limited to navigation controls, patterns, tables and the like. The information displayed in the application windows (e.g., images and text) are designed according to the size of the windows. When the application windows are initiated, the information is designed to be displayed in the windows according to the developer's specifications. Accordingly, the application window as designed by the developer and/or designer may not appear as the developer and/or designer intended, because of the various screens and various screen resolutions currently used in the market.

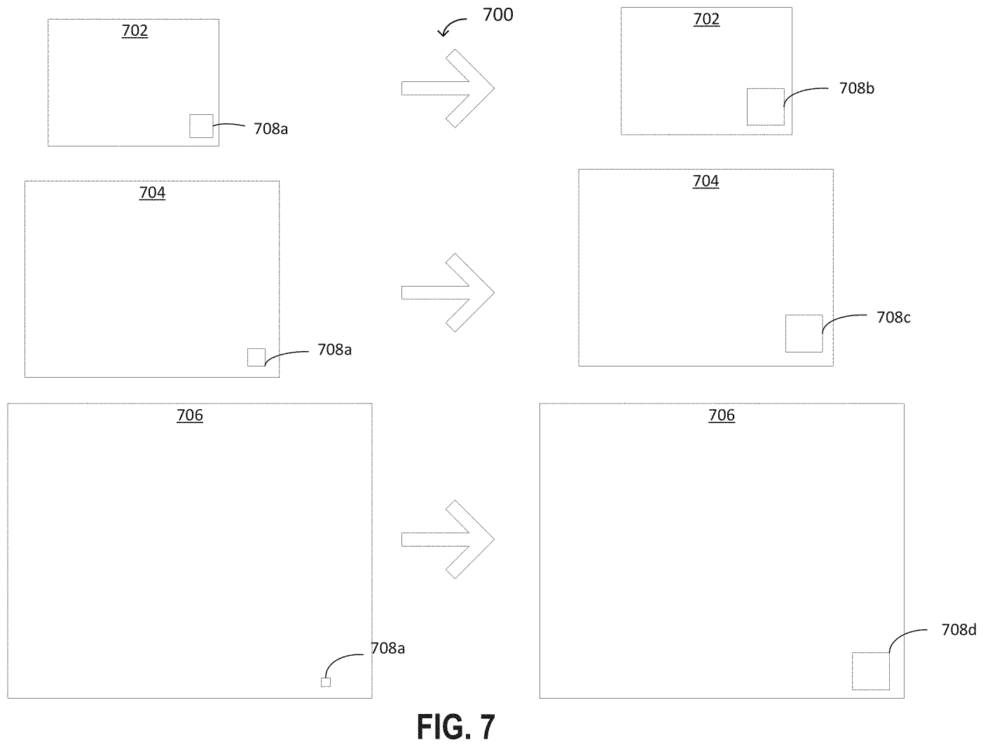

Stretching the bitmap may stretch the image up or down according to the screen resolution. However, stretching the bitmap may create an inconsistent user experience. For example, a stretched bitmap may make the bitmap appear blurry on some screens and not blurry on other screens. In a particular example, on a high resolution screen, stretching the bitmap may make the image appear visibly deficient on the screen (e.g., too few pixels are used to display the content of a digital image). In contrast, a stretched bitmap may not be as noticeable on a lower resolution screen because the pixel density on the lower resolution screen does not make the bitmap stretching as apparent. Scaling the pixels, as opposed to stretching them, offers the advantages of changing the size of the image while maintaining a crisp image. The image sizes may be scaled by using separate high-resolution images. An example of scaling a pixel, according to a scale factor across various resolution screens is discussed herein, with reference to FIG. 7.

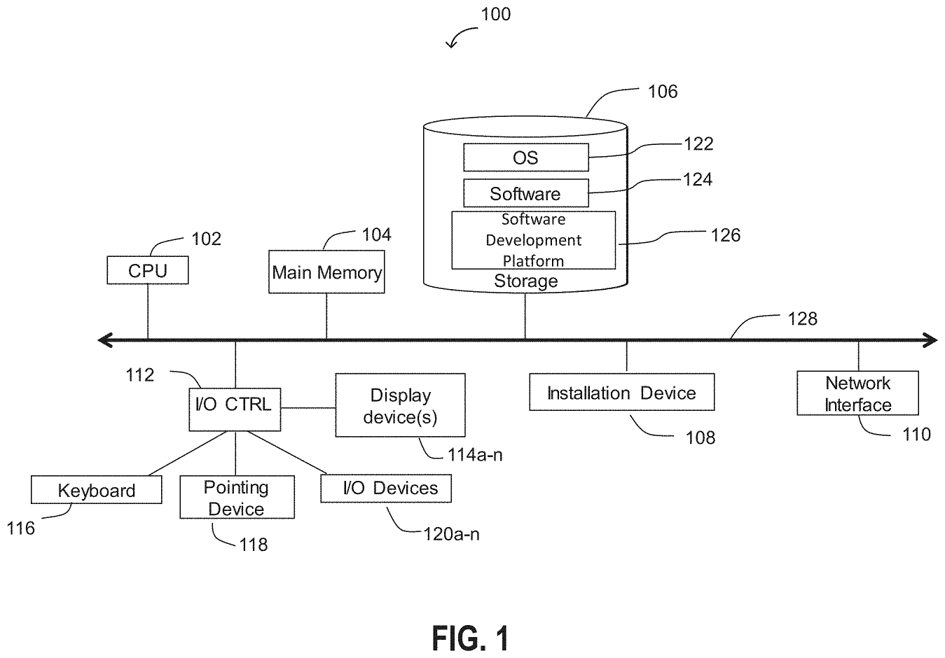

In some contexts, the above-noted problem of stretched bitmaps may be addressed by creating a multi-resolution style library in the application. In the multi-resolution style library, images previously generated may be stored in the application as a bitmap at multiple resolutions. Bitmaps are stored of images at multiple resolutions regardless of whether the application uses the image. Thus, the multi-resolution style library can consume a significant amount of space in memory (e.g., memory 104 in FIG. 1) in the computing device using the application.

In some contexts, vector graphics or vector based graphics can be composed from a fixed set of shapes. Vector graphics use shapes, numbers and coordinates rather than pixels to render graphics in an image. While vector graphics can be scaled in an application, vector graphics do not have the same customization as bitmaps. Further, some operating systems, such as the Windows® operating system, do not have full support for processing vector graphics.

Developers may use one or more tools such as various user interface component libraries to help design applications on an operating system such as, but not limited to a Windows® system. One example tool used by developers to design applications on Windows® systems is RAD Studio created by Embarcadero, which includes a user interface component library, known as the Visual Component Library (“VCL”) that supplies developers with components and controls that can be used to develop applications. The present disclosure relates to developers building applications that display consistent user experiences across various screens using libraries and tools including, but not limited to the tools described above.

Referring now to FIG. 1, a block diagram of a computing device is displayed that is capable of employing and being configured with a toolkit to develop applications, according to some arrangements. The computing device 100 can be useful for practicing one or more arrangements of the present disclosure. As shown in FIG. 1, in some arrangements, the computing device 100 includes a central processing unit 102, a main memory unit 104, a storage device 106, an installation device 108, a network interface 110, an input/output (I/O) controller 112, one or more display devices 114 (e.g., 114a-114n), a keyboard 116, and a pointing device 118 (e.g., a mouse). The storage device 106 can include, without limitation, an operating system (OS) 122, software 124 implemented via the OS 122, and a Software Development Platform 126 such as a toolkit for developing other software (e.g., software 124). The Software Development Platform 126 can be one of the different types of software 124 implemented by the OS. The computing device 100 can also include additional optional elements, for example, such as a memory port, a bridge, one or more input/output devices 120 (e.g., 120a-120n), and cache memory in communication with the central processing unit 102.

In some arrangements, the central processing unit 102 can be any suitable logic circuitry that responds to and processes instructions fetched from the main memory unit 104. In some arrangements, the central processing unit 102 is provided by a microprocessor unit. For example, in some arrangements, the microprocessor unit can include one or more microprocessors manufactured by Intel Corporation of Mountain View, Calif., Motorola Corporation of Schaumburg, Ill., the ARM processor and TEGRA system on a chip (SoC) manufactured by Nvidia of Santa Clara, Calif., the POWER7 processor, those manufactured by International Business Machines of White Plains, N.Y., and/or by Advanced Micro Devices of Sunnyvale, Calif. The computing device 100 can be based on any of these processors, or any other suitable processor capable of operating as described herein. In various arrangements, the central processing unit 102 can utilize instruction level parallelism, thread level parallelism, different levels of cache, and/or multi-core processors. A multi-core processor can include two or more processing units on a single computing component. Examples of a multi-core processors include the AMD PHENOM IIX2, INTEL CORE i5 and INTEL CORE i7.

In some arrangements, the main memory unit 104 can include one or more memory chips capable of storing data and allowing any storage location to be directly accessed by the central processing unit 102. In some arrangements, the main memory unit 104 can be volatile and faster than the storage device 106. In various arrangements, the main memory unit 104 can be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), and/or Extreme Data Rate DRAM (XDR DRAM). In some arrangements, the main memory 104 or the storage device 106 can be non-volatile memory, for example, such as non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), and/or Millipede memory. The main memory 104 can be based on any of the above described memory chips, or any other available memory chips capable of operating as described herein. In some arrangements, the central processing unit 102 communicates with the main memory unit 104 via a system bus 128 (described in more detail herein). In other arrangements, the central processing unit 102 can communicate directly with the main memory unit 104 via a memory port.

In some arrangements, the central processing unit 102 can communicate directly with cache memory via a secondary bus, sometimes referred to as a backside bus. In other arrangements, the central processing unit 102 can communicate with cache memory using the system bus 128. Cache memory typically has a faster response time than the main memory unit 104, and is typically provided by SRAM, BSRAM, or EDRAM. In some arrangements, the central processing unit 102 communicates with various I/O devices 120 via a local system bus (e.g., the system bus 128). Various buses can be used to connect the central processing unit 102 to any of the I/O devices 120, including a PCI bus, a PCI-X bus, or a PCI-Express bus, or a NuBus. In arrangements in which the I/O devices 120 include a video display device 114, the central processing unit 102 can use an Advanced Graphics Port (AGP) to communicate with the display device 114 or the I/O controller 112 for the display device 114.

In various arrangements, a wide variety of I/O devices 120a-120n can be included in the computing device 100. For example, in various arrangements, the input devices of the I/O devices 120a-n can include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, and/or other sensors. In various arrangements, the output devices of the I/O devices 120a-n can include, for example, video displays, graphical displays, speakers, headphones, inkjet printers, laser printers, and/or 3D printers.

In some arrangements, I/O devices 120a-120n can include a combination of multiple input or output devices, such as, for example, Microsoft KINECT, Nintendo Wiimote for the WII, Nintendo WII U GAMEPAD, Apple IPHONE, Android based smart phones, and/or the like. In some arrangements, some of the I/O devices 120a-120n can allow gesture recognition inputs through a combination of some of the inputs and outputs. In some arrangements, some of the I/O devices 120a-120n can provide for facial recognition, which can be utilized as an input for different purposes including authentication and other commands. In some arrangements, some of the I/O devices 120a-120n can provide for voice recognition and inputs, such as, for example, Microsoft KINECT, SIRI for IPHONE by Apple, Google Now or Google Voice Search, and/or the like.

In some arrangements, addition I/O devices 120a-120n can have both input and output capabilities, including, for example, haptic feedback devices, touchscreen displays, multi-touch displays, and/or the like. Touchscreen, multi-touch displays, touchpads, touch mice, or other touch sensing devices can use different technologies to sense touch, including, for example, capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), force-based sensing technologies, and/or the like. Some multi-touch devices can allow two or more contact points with the surface, allowing advanced functionality including, for example, pinch, spread, rotate, scroll, and/or other gestures. Some touchscreen devices, including, for example, Microsoft PIXELSENSE and Multi-Touch Collaboration Wall, can have larger surfaces, such as on a table-top or on a wall, and can also interact with other electronic devices. In some arrangements, some of the I/O devices 120a-120n, display devices 114a-114n, or group of devices can be augmented reality devices. In some arrangements, the I/O devices (e.g., keyboard 116, pointing device 118, display devices 114, and/or I/O devices 120) can be controlled by the I/O controller 112. In some arrangements, an I/O device can also provide storage and/or an installation medium (e.g., installation device 108) for the computing device 100. In still other arrangements, the computing device 100 can provide USB connections to receive handheld USB storage devices. In further arrangements, an I/O device 120 can be a bridge between the system bus 128 and an external communication bus, for example, such as a USB bus, a SCSI bus, a FireWire bus, an Ethernet bus, a Gigabit Ethernet bus, a Fibre Channel bus, a Thunderbolt bus, and/or the like.

In some arrangements, the display devices 114a-114n can be connected to the I/O controller 112. In various arrangements, the display devices 114a-114n can include, for example, a liquid crystal display (LCD), a thin film transistor LCD (TFT-LCD), a blue phase LCD, an electronic papers (e-ink) display, a flexible display, a light emitting diode display (LED), a digital light processing (DLP) display, a liquid crystal on silicon (LCOS) display, an organic light-emitting diode (OLED) display, an active-matrix organic light-emitting diode (AMOLED) display, a liquid crystal laser display, a time-multiplexed optical shutter (TMOS) display, a 3D or stereoscopic display, and/or the like. Examples of 3D displays can include, for example, stereoscopy, polarization filters, active shutters, autostereoscopy, and/or the like. Display devices 114a-114n can also include a head-mounted display (HMD). In some arrangements, display devices 114a-114n or the corresponding I/O controllers 112 can be controlled through or have hardware support for OPENGL, DIRECTX API, and/or other graphics libraries.

In some arrangements, the computing device 100 can include or connect to multiple display devices 114a-114n, which each can be of the same or different type and/or form. As such, any of the I/O devices 120a-120n and/or the I/O controller 112 can include any type and/or form of suitable hardware, software, or combination of hardware and software to support, enable or provide for the connection and use of multiple display devices 114a-114n by the computing device 100. For example, the computing device 100 can include any type and/or form of video adapter, video card, driver, and/or library to interface, communicate, connect or otherwise use the display devices 114a-114n. In one arrangement, a video adapter can include multiple connectors to interface to multiple display devices 114a-114n. In other arrangements, the computing device 100 can include multiple video adapters, with each video adapter connected to one or more of the display devices 114a-114n. In some arrangements, any portion of the operating system 122 of the computing device 100 can be configured for using multiple displays 114a-114n. In other arrangements, one or more of the display devices 114a-114n can be provided by one or more other computing devices connected to the computing device 100, via a network. In some arrangements software can be designed and constructed to use another computer's display device as a second display device 114a for the computing device 100. For example, in one arrangement, an Apple iPad can connect to a computing device 100 and use the display of the computing device 100 as an additional display screen that can be used as an extended desktop. One of ordinarily skill in the art will recognize and appreciate the various ways and arrangements that a computing device 100 can be configured to have multiple display devices 114a-114n.

In some arrangements, the storage device 106 (e.g. one or more hard disk drives or redundant arrays of independent disks) can store the operating system 122, and/or other related software, and can store application software programs 124 such as any program related to the software instance of the Software Development Platform 126. Examples of the storage device 106 can include hard disk drive (HDD), optical drive including CD drive, DVD drive, and/or BLU-RAY drive, solid-state drive (SSD), USB flash drive, and/or any other suitable device for storing data. Some storage devices 106 can include multiple volatile and non-volatile memories, such as, for example, solid state hybrid drives that combine hard disks with solid state cache. Some storage devices 106 can include non-volatile, mutable, and/or read-only. Some storage devices 106 can be internal and can connect to the computing device 100 via the bus 128. Some storage devices 106 can be external and can be connect to the computing device 100 via an I/O device 120 that provides an external bus. Some storage devices 106 can connect to the computing device 100 via the network interface 110 over a network, such as, for example, the Remote Disk for MACBOOK AIR by Apple. Some computing devices 100 may not require a non-volatile storage device 106 and can be thin clients or zero clients. Some storage devices 106 can also be used as an installation device 108, and can be suitable for installing software and programs. Additionally, the operating system and the software can be run from a bootable medium, for example, such as a bootable CD (e.g. KNOPPIX), which can be a bootable CD for GNU/Linux that is available as a GNU/Linux distribution from knoppix.net.

In some arrangements, the computing device 100 can also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform can facilitate installation of software on the computing device 100. An application distribution platform can include a repository of applications on a server or a cloud, which the computing device 100 can access over a network (e.g., the Internet). An application distribution platform can include application developed and provided by various developers. A user of the computing device 100 can select, purchase, and/or download an application via the application distribution platform.

In some arrangements, the computing device 100 can include the network interface 110 to interface to a network through a variety of connections including, but not limited to, for example, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, and/or some combination of any or all of the above. Connections can be established using a variety of communication protocols (e.g., TCP/IP, Ethernet, ARCNET, SONET, SDH, Fiber Distributed Data Interface (FDDI), IEEE 802.11/b/g/n/ac CDMA, GSM, WiMax and direct asynchronous connections). In one arrangement, the computing device 100 communicates with other computing devices via any type and/or form of gateway or tunneling protocol (e.g. Secure Socket Layer (SSL) or Transport Layer Security (TLS), or the Citrix Gateway Protocol manufactured by Citrix Systems, Inc. of Ft. Lauderdale, Fla.). In some arrangements, the network interface 110 can include, for example, a built-in network adapter, network interface card, PCMCIA network card, EXPRESSCARD network card, card bus network adapter, wireless network adapter, USB network adapter, modem, and/or any other suitable device for interfacing the computing device 100 to any type of network capable of communication and performing the operations described herein.

In some arrangements, the computing device 100 can operate under the control of the operating system 122, which controls scheduling of tasks and access to system resources. In various arrangements, the computing device 100 can run any suitable operating system 122, such as, for example, any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, and/or any other suitable operating system capable of running on the computing device 100 and performing the operations described herein. Some examples of operating systems 122 include, but are not limited to: WINDOWS 2000, WINDOWS Server 2012, WINDOWS CE, WINDOWS Phone, WINDOWS XP, WINDOWS VISTA, WINDOWS 7, WINDOWS RT, WINDOWS 8, WINDOWS 10, and/or the like, all of which are manufactured by Microsoft Corporation of Redmond, Wash.; MAC OS and iOS, manufactured by Apple, Inc. of Cupertino, Calif.; Linux, a freely-available operating system, e.g. Linux Mint distribution (“distro”) or Ubuntu, distributed by Canonical Ltd. of London, United Kingdom; Unix or other Unix-like derivative operating systems; and Android, designed by Google, of Mountain View, Calif., but can include others. Some operating systems 122, including, for example, the CHROME OS by Google, can be used on zero clients or thin clients (e.g., CHROMEBOOKS).

In various arrangements, the computing device 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, and/or any other suitable type and/or form of computing, telecommunications, or media device that is capable of communication. The computing device 100 has sufficient processor power and memory capacity to perform the operations described herein. In some arrangements, the computing device 100 can have different processors, operating systems, and input devices consistent with the device.

In some arrangements, the computing device 100 can be a gaming system. For example, the computing device 100 can include a PLAYSTATION (1, 2, 3, 4, and/or the like), a PERSONAL PLAYSTATION PORTABLE (PSP), and/or a PLAYSTATION VITA device manufactured by the Sony Corporation of Tokyo, Japan, a NINTENDO DS, NINTENDO 3DS, NINTENDO WII, NINTENDO WII U, and/or Nintendo Switch device manufactured by Nintendo Co., Ltd., of Kyoto, Japan, an XBOX 360, XBOX one, and/or the like manufactured by the Microsoft Corporation of Redmond, Wash., and/or the like.

In some arrangements, the computing device 100 can be a digital audio player such as the Apple IPOD, IPOD Touch, and IPOD NANO lines of devices, manufactured by Apple Computer of Cupertino, Calif. Some digital audio players can have other functionality, including, for example, a gaming system or any functionality made available by an application from a digital application distribution platform. For example, the IPOD Touch can access the Apple App Store. In some arrangements, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and/or .mp4 MPEG-4 (H.264/MPEG-4 AVC) video file formats.

In some arrangements, the computing device 100 can be a tablet, for example, such as the IPAD line of devices by Apple; GALAXY TAB family of devices by Samsung; KINDLE FIRE, by Amazon.com, Inc. of Seattle, Wash.; and/or the like. In other arrangements, the computing device 100 can be an eBook reader, such as, for example, the KINDLE family of devices by Amazon.com, or the NOOK family of devices by Barnes & Noble, Inc. of New York City, N.Y.

While some non-limiting examples of various computing devices 100 and components thereof have been described herein, the present disclosure is not limiting. For example, other suitable computing devices and/or components thereof relating to one or more of the various aspects of the operating environments and components described above in the context of the systems and methods disclosed herein are contemplated, as will be apparent to those having ordinary skill in the art.

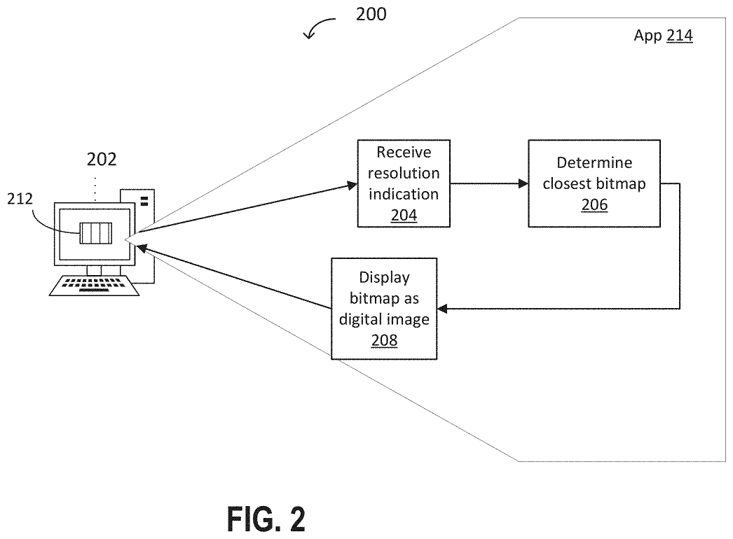

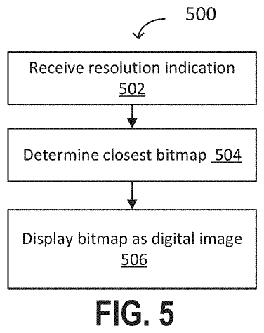

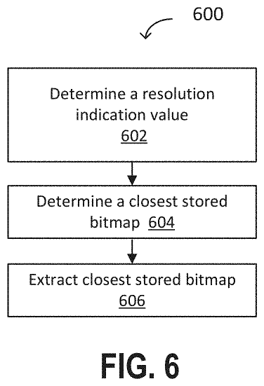

FIG. 2 is a schematic diagram of a system 200 executing an application that selects and displays bitmaps according to a screen resolution, according to some arrangements. The computer system 200 in FIG. 2 executes application 214 that determines the bitmap to be displayed for computing system 200. An example method of determining the bitmap for the computing system is described herein, with reference to at least FIGS. 5 and 6. Application 214 may be software (e.g., software 124) developed by a software toolkit (e.g., Software Development Platform 126 such as, but not limited to VCL). A computer 202 with OS 122 may be a central component of computing system 200.

At some point during application 214 launch process, application 214 may receive a resolution indication as shown by block 204. In one non-limiting example, a resolution indication may be determined based on the reception of a message from OS 122. An application that obtains the DPI information (e.g., a notice of an adjusted resolution) from OS 122 may be considered DPI aware. In another example, a user may specify a preference (via keyboard 116 or pointing device 118) for a different resolution via settings, for instance, in the OS 122. The user's preference may trigger the OS 122 to generate a message that is received by application 214 and includes a resolution indication.

At block 206, based on the resolution indication, the application may determine a closest bitmap that may appear to aesthetically match the environment of the application (e.g., the images used in the application may appear as if the images belong on the screen and not that the images were stretched). An example method for determining an appropriate bitmap based on the resolution indication is discussed herein, with reference to FIGS. 5 and 6.

In block 208, application 214 may display the determined bitmap (e.g., the bitmap determined at block 206) on the screen of computer 202. The determined bitmap may display image 212. Image 212 is an image that has a pixel density that is supported by the screen of the computer 202. That is, image 212 appears crisp (e.g., the lines in image 212 are not blurry, choppy, or small) because the DPI of image 212 matches, or closely matches, the DPI resolution of the screen.

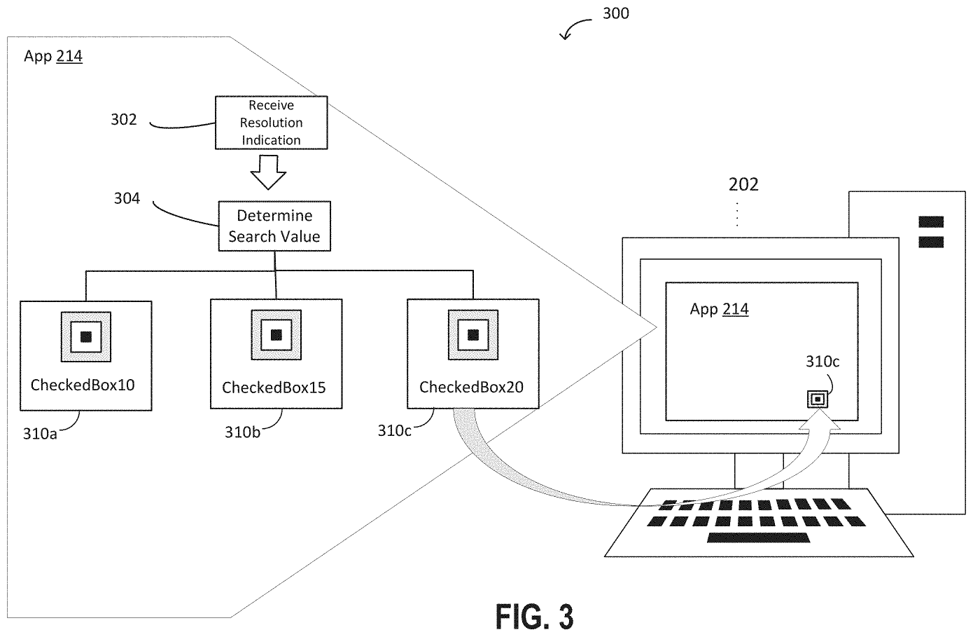

FIG. 3 is a schematic diagram showing an example system 300 selecting a bitmap out of a collection of bitmaps, according to some arrangements. Application 214 on computing device 202 receives an indication 302 of a resolution. As discussed herein, in some embodiments the resolution indication may be information provided in a message from OS 122, where the indicated resolution is contained in the message. In other embodiments, the resolution indication received may be a user preference (e.g., input to a computer via keyboard 116, pointing device 118 or other user input device).

In other embodiments, the resolution indication received from the user may include or be in the form of a user-selected scale factor (e.g., a user selecting a scale factor in a settings menu of the computer 202). Scale factors are discussed herein, with reference to FIG. 7. In brief overview, a scale factor is an amount a pixel may appear to change, as a percentage or other reference to the pre-changed pixel. Accordingly, in one non-limiting example, a scale factor indication 302 may include or be in the form of a percentage (such as 100%, 150%, 180% or other suitable percentage). In a particular example, the received resolution indication 302 may be a user-selected scale factor of 180%.

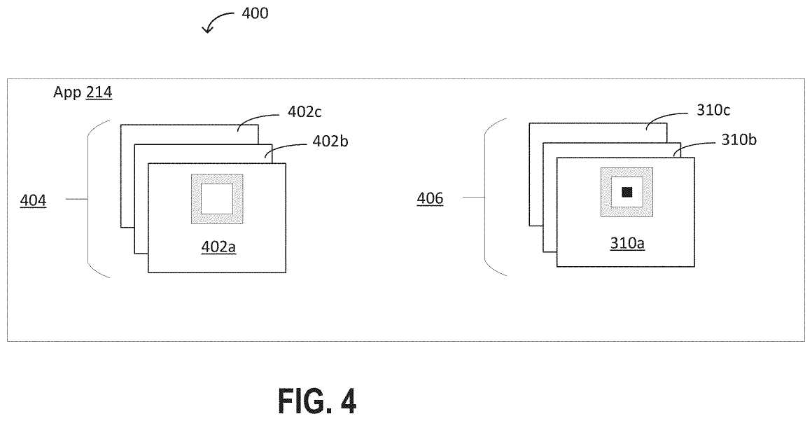

As shown in 304, application 214 determines a search value based on the resolution indication (such as, but not limited to scale factor) received at 302. In some examples, the search value may be derived by extracting the first two digits of the scale factor percentage. Thus, in the particular example in which the scale factor indication received at 302 includes a percentage of 180%, a search value of 18 is determined at 304. The first two digits of the scale factor may be determined by dividing the scale factor by 10, for instance. In other examples, other suitable processes for determining a search value based on the scale factor indication may be employed. The first two digits of the scale factor (or other search value derived from the scale factor) may be used in a search procedure (e.g., to search collections of stored bitmaps as shown by 404 and 406 in FIG. 4), to search the application 214 for pre-loaded scaled images that match (or closely match) the desired resolution in 302.

The application may determine the scaled image that matches (or most closely matches) the desired resolution in 302 by comparing the search value with values (e.g., two digits) used in a naming convention of the stored bitmaps. The naming convention will be discussed further herein, with reference to FIGS. 5 and 6. For example, according to the naming convention used to store the bitmaps, the value (e.g., two digits value) associated with a scaled image of the image “checkedbox” in 310a is “10.” The naming convention uses the two digits “10” to indicate that a bitmap is stored in application 214 that represents the “checkedbox” image (e.g., image 310a) at a resolution (e.g., default resolution 1×). Similarly, the value (e.g., two digits value) associated with a scaled image of the image “checkedbox” in 310b is “15.” The naming convention uses the two digits “15” to indicate that a bitmap is stored in application 214 that represents the “checkedbox” image (e.g., image 310b) at a higher resolution (e.g., scaled by 1.5×). Similarly, the value (e.g., two digits value) associated with a scaled image of the image “checkedbox” in 310c is “20.” The naming convention uses the two digits “20” to indicate that a bitmap is stored in application 214 that represents the “checkedbox” image (“e.g., image 310c) at a higher resolution (e.g., scaled by 2×). In other examples, other values and numbers of values may be employed and be associated with scaled images (e.g., checkedbox).

Application 214 may find the pre-loaded scaled bitmap that most closely matches an image displayed at a desired resolution by determining a smallest difference between the search value (determined from 304) and values of scaling according to the naming conventions of the stored bitmaps. For example, the difference between the two digits in block 304 (e.g., the search value) and the two digits associated with image 310a (e.g., scaling values associated with the stored bitmap indicated by the naming convention) is 8 (e.g., 18−10=8). The difference between the two digits in block 304 and the two digits associated with image 310b is 3 (e.g., 18−15=3). Similarly, the difference between the two digits in block 304 and the two digits associated with image 310c is 2 (e.g., 20−18=2). Therefore, because the difference between the two digits in image 310b and the two digits in block 304 is the smallest (e.g., 2 compared to 3 and 8), application 214 will determine that image 310c will represent the desired scale factor in block 302 and display image 310c. Accordingly, image 310c is shown as displayed on computer 202 in application 214.

Accordingly, application 214 may not need to store images of every possible resolution. Instead, application 214 stores certain relevant images at certain resolutions such that a selected image to be displayed sufficiently matches the desired resolution (by selecting the naming convention value of the stored image that is closest to the search value) without bloating the size of application 214 and while still maintaining the ability to fully customize images. In the event image 310b was closest to the two digit representation of the scale factor in block 304 (e.g., the difference was 1 instead of 3, so when compared with 2 and 8, 1 would be the smallest and thus image 310b would be selected) then application 214 would select and display image 310b.

FIG. 4 is a generalized diagram representing a storage system 400 in an application, according to some arrangements. Application 214 (FIG. 2) determines the closest stored bitmap (e.g., block 504 in FIG. 5) according to the available bitmaps that have been designed and stored in the application. The collection of stored bitmaps 404 may include multiple bitmaps of various resolutions (e.g., 402a, 402b, 402c, etc.). The collection of stored bitmaps 404 may be the stored bitmaps related to an unchecked box. Each of the bitmaps (e.g., 402a, 402b, 402c) may be scaled to a certain pixel density, as indicated by a scale factor. The scale factor is discussed further herein, with reference to FIG. 7. The scale factors of the bitmaps 402a, 402b, 402c may correspond to any suitable scale factors including, but not limited to 10×, 15× and 20× respectively. As shown in FIG. 3, the scale factor, indicated by the naming convention, will be compared to the resolution indication. A bitmap will be selected based on the stored bitmaps in collection 404. Application 214 may include or store several bitmaps. In the example shown in FIG. 3, the bitmaps 310a, 310b, and 310c are scaled versions of the bitmaps with scale factors of 10×, 15× and 20×. Thus, application 214 stores (in one non-limiting example) two collections of bitmaps.

In some arrangements, the stored bitmaps may be bitmaps preloaded in application 214. Common pre-loaded bitmaps may include, but not limited to components with specific graphical elements. For instance, components with specific graphical elements may include form components with system buttons (or graphical elements) that minimize, maximize, restore, close, and help. Components may further include ToolWindow components with system close button graphical elements. Components may further include button components with command link glyph graphical elements. Components may further include checkbox components with checked, unchecked, and mixed graphical elements. Components may further include radial buttons with checked and unchecked graphical elements. Components may further include scrollbar components with left, right, top and down button arrow (or other symbols) graphical elements. Components may further include Menubar components with restore, minimize, and close button graphical elements. Components may further include ListBox components with checkbox graphical elements. Components may further include ComboBox components with drop down arrow (or other symbols) graphical elements. Components may further include SpeedButton components with chevron glyph (or other symbols) graphical elements. Components may further include TrackBar components with horizontal and vertical thumbs and trackbars, and left, right, top and bottom marker graphical elements. Components may further include ControlBar components with horizontal and vertical grabber graphical elements. Components may further include StatusBar components with gripper graphical elements. Components may further include CategoryPanel components with group element opened and closed chevron (or other symbols), button opened and closed chevron (or other symbols) graphical elements. Components may further include DBNavigator components with action button graphical elements. Components may further include MediaPlayer components with action button graphical elements. Components may further include DBGrid components with standard, edit, insert, multi dot and multi arrow cursors graphical elements. Components may further include SearchBox components with text and audio glyph graphical components. Components may further include Numberbox components with up and down arrows (or other symbols) graphical elements.

In other arrangements, the stored bitmaps may correspond to other pre-defined displayable items or may be designed by developers using application 214. In a particular example, the bitmaps are entirely customizable. The bitmaps, whether preloaded in the application or created by developers, are both named according to a naming convention, as discussed further herein, with reference to FIGS. 5 and 6. The naming convention allows application 214 to search through stored bitmaps and find a bitmap to display in regards to the received resolution indication.

A developer may select which bitmaps are loaded into application 214. For example, a developer may choose to load into application 214 only certain bitmaps used in graphics where the displayed graphic may be visibly impacted when rendered on a high resolution screen. For example, a purple rectangle in high resolution, or low resolution, may appear to be the same (e.g., a purple rectangle may not be visually distorted when displayed on different screens). In contrast, a crisscross pattern within the purple rectangle may appear visually distinguishable when displayed on a high resolution screen as compared to when displayed on a low resolution screen. For example, the diagonal lines of the crisscross pattern on the high resolution screen may appear “choppy” like a staircase, because the pixels in the image have been stretched (or are simply lacking) when displayed on a high resolution screen. In another example, a gradient image (e.g., color fading in a smooth transition) is an image that may degrade when displayed in high resolution.

Further, some images do not need to be scaled because their visual representation in high resolution and in low resolution is similar. For example, in addition to the purple rectangle as discussed above, a one-pixel border around an image may not need to be scaled. No matter the resolution of the screen, there will always be a one-pixel border around the image.

Accordingly, a developer may choose to store bitmaps that are relevant (e.g., will make a visual difference when displayed as an image in high resolution vs when displayed as an image in low resolution). The freedom to store relevant bitmaps frees up the space that application 214 requires in memory 104.

FIG. 5 is a flow chart of a method 500 of creating a consistent user experience, according to some arrangements. As shown in block 502, application 214 may receive a resolution indication. As discussed herein, the resolution indication may be in the form of a message from an operating system (e.g., OS 122). A user may trigger the OS 122 to generate the message with the resolution indication from the operating system by selecting a preferred resolution scale using one or more OS 122 settings (e.g., via keyboard 116 or pointing device 118). Alternatively, a user may trigger the OS 122 to generate the message with the resolution indication by moving a window and/or form of the application 214 from a first screen with a first resolution to a second screen with a second resolution. The resolution indication may be in the form of a scale factor (e.g., a percent).

As shown in block 504, the application 214 may determine a closest stored bitmap. Application 214 may determine the closest stored bitmap using the received resolution indication from block 502 and a name of each of the stored bitmaps (e.g., the collections of bitmaps 404 and 406 in FIG. 4). An example method for determining the closest stored bitmap is discussed herein, with reference for FIG. 6. Prior to the storage of the bitmaps, the bitmaps are generated. As discussed herein, the generation of the bitmaps may have been done by the developers of application 214. Alternatively, generation of the bitmaps may be performed by developers using application 214.

Upon the completion of the generated bitmap, the generated bitmap may be saved and stored according to a naming convention. The naming convention allows application 214 to quickly determine the closest stored bitmap such that the visual lag during the selection of the bitmaps is reduced. The naming convention may include the name of the bitmap (e.g., the logical name of the bitmap defined at the control level, by a developer, for instance) concatenated with a resolution representation of the stored bitmap. The resolution representation of the stored bitmap may be the scale factor of the stored bitmap, for example, but not limited to, as a percentage divided by 10. In certain examples, the resolution may be the DPI resolution in percent, divided by 10.

As shown in block 506, the closest stored bitmap may be displayed as a digital image. The displayed digital image may appear consistent to the user on various screens (e.g., the displayed image does not appear “blurry” or “choppy” indicating an incorrect pixel density and/or stretching of pixels when viewed on various screens).

FIG. 6 is a flow chart of a method 600 of determining the closest stored bitmap, according to some arrangements. As shown in block 602, application 214 may determine the resolution indication value such as, but not limited to a two digit representation of the received resolution indication, as discussed herein. For example, in cases where 1000% scaling is necessary to display high resolution images, the resolution indication value may be a three digit representation.

As shown in block 604, the closest stored bitmap based on the naming convention (such as, but not limited to a two digit representation) of the stored bitmaps may be determined (e.g., the collection of stored bitmaps being the collections 404 and 406 in FIG. 4). The closest stored bitmap may be determined by evaluating the difference in resolution between naming convention representing a resolution representation of the one of more stored bitmaps and the resolution indication value. The resolution representation of the one or more stored bitmaps may be extracted based on the naming convention.

As discussed herein, the naming convention may include the name of the bitmap (e.g., the logical name of the bitmap defined at the control level, by a developer, for instance) concatenated with a resolution representation of the stored bitmap. The resolution representation of the stored bitmap may be the scale factor of the stored bitmap for example, as a percentage divided by 10 or other suitable value. In certain examples, the resolution may be the DPI resolution in percent, divided by 10. The naming convention allows application 214 to select a bitmap to be displayed as a digital image quickly and can reduce the storage needs for storing bitmaps.

Application 214 may determine the stored bitmap that matches the resolution indication value (such as, but not limited to a two digit representation of the received resolution indication) by comparing the difference between the resolution indication value (e.g., the two digit representation of the received resolution indication) and the resolutions according to the naming convention for the stored bitmaps. For example, the two digit representation of the received resolution indication can be compared to various resolutions extracted from the names of the stored bitmaps. The stored bitmap that results in the smallest difference between the resolution associated with the stored bitmap (indicated in the name by the naming convention) and the two digit representation of the received resolution indication may be determined to be the closest stored bitmap.

As shown in block 606, the bitmap determined to be the closest stored bitmap out of the stored bitmaps (e.g., the collection of stored bitmaps shown in 404 and 406 in FIG. 4) may be extracted. The extracted bitmap may be displayed on a screen (e.g., the determined bitmap displayed in FIG. 2B).

FIG. 7 is an example 700 of scaled pixels according to a scale factor, according to some arrangements. In this non-limiting example, three screens are shown with various resolutions and sizes: 702 is a 14-inch screen with a 1280×800 resolution, 704 is a 24-inch screen with a 1680×1050 resolution, and 706 is a 32-inch screen with a 1920×1440 resolution. The same pixel 708a is shown on each of the screens (e.g., 702, 704, and 706). However, the same pixel visually appears smaller as the size and pixel density of the screen increases. Pixel 708b on screen 702 is a scaled version of pixel 708a. Note that the pixels are still the same (thus the number is still 708) but the version of the pixel (e.g., 708a as compared to 708b) is different because of the visual difference in pixel size. An effective pixel (e.g., 708b) is a group of pixels that represent one physical pixel (708a).

The scaled pixel (e.g., 708) may be scaled by a scale factor, where the scale factor is the ratio between the effective pixel and the physical pixel. For example, a user may prefer that pixel 708a appear as pixel 708b. Thus, a user may scale pixel 708a 150% to achieve the visual effect of pixel 708b, meaning pixel 708b appears visually 1.5× greater than pixel 708a on screen 702. To create the same sized pixel on screen 704, pixel 708a on screen 704 may be scaled by a factor of 200% (e.g., 2× greater than the pixel on screen 704). Similarly, pixel 708a on screen 706 may be scaled 250% (e.g., 2.5× greater than pixel 708a on screen 706). Thus, a user is viewing all three screens would see the same pixel (e.g., pixel 708), creating a consistent user experience, although the pixels themselves are scaled differently on each screen.

In an alternate example (not shown) two screens may be used to display content of one computer. Similarly to FIG. 7, the screens may have different resolutions and different sizes. For example, the first screen may be a 32-inch monitor and the second screen may be a 24-inch monitor. The screen resolution of the first monitor may be 1920×1440 and the screen resolution of the second monitor may be 1920×1200. Although the screens have identical horizontal resolutions (e.g., 1920 pixels in a row), the image on the first screen may appear smaller than the image on the second screen. Thus, to achieve the same visual display when an application is moved from the first screen to the second screen, the image on the first screen may be scaled up. When the application changes from the first screen to the second screen, the OS 122 may send a message (e.g., the Windows® OS will send a message called WM_DPICHANGED in response to the DPI for an application changing) such that application 214 is aware of the new DPI on the screen, and application 214 may search for the corresponding bitmaps (e.g., the method described in FIG. 5)

The various examples illustrated and described are provided merely as examples to illustrate various features of the claims. However, features shown and described with respect to any given example are not necessarily limited to the associated example and can be used or combined with other examples that are shown and described. Further, the claims are not intended to be limited by any one example.

The foregoing method descriptions and the process flow diagrams are provided merely as illustrative examples and are not intended to require or imply that the steps of various examples must be performed in the order presented. As will be appreciated by one of skill in the art the order of steps in the foregoing examples can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the examples disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but, in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, some steps or methods can be performed by circuitry that is specific to a given function.

In some exemplary examples, the functions described can be implemented in hardware, software, firmware, or any combination thereof. If implemented in software, the functions can be stored as one or more instructions or code on a non-transitory computer-readable storage medium or non-transitory processor-readable storage medium. The steps of a method or algorithm disclosed herein can be embodied in a processor-executable software module which can reside on a non-transitory computer-readable or processor-readable storage medium. Non-transitory computer-readable or processor-readable storage media can be any storage media that can be accessed by a computer or a processor. By way of example but not limitation, such non-transitory computer-readable or processor-readable storage media can include RAM, ROM, EEPROM, FLASH memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm can reside as one or any combination or set of codes and/or instructions on a non-transitory processor-readable storage medium and/or computer-readable storage medium, which can be incorporated into a computer program product.

The preceding description of the disclosed examples is provided to enable any person skilled in the art to make or use the present disclosure. Various modifications to these examples will be readily apparent to those skilled in the art, and the generic principles defined herein can be applied to some examples without departing from the spirit or scope of the disclosure. Thus, the present disclosure is not intended to be limited to the examples shown herein but is to be accorded the widest scope consistent with the following claims and the principles and novel features disclosed herein.

What is claimed is:

1. A method of creating a consistent application user experience comprising:
determining a resolution indication for a resolution of a display device;
determining a closest stored bitmap from a plurality of stored bitmaps according to the resolution indication, wherein each of the plurality of stored bitmaps are named according to a naming convention, the naming convention associating a name of one of the plurality of stored bitmaps and a resolution representation value of the one of the plurality of stored bitmaps to the one of the plurality of stored bitmaps, the plurality of stored bitmaps being one or more components for controls, each of the one or more components for controls including one or more graphical elements; and
displaying a digital image corresponding to the closest stored bitmap.

2. The method of claim 1, wherein the resolution indication is based on a message from an operating system.

3. The method of claim 1, wherein the resolution indication is determined based on a user command.

4. The method of claim 1, wherein determining the closest stored bitmap comprises:
determining a resolution representation of the resolution indication; and
determining the closest stored bitmap based on the resolution representation of the resolution indication and the plurality of stored bitmaps, the closest stored bitmap determined by comparing the resolution representation of the resolution indication to the resolution representation of each of the plurality of stored bitmaps, and selecting the closest stored bitmap based on a smallest difference between the resolution representation of the one of the plurality of stored bitmaps and the resolution representation of the resolution indication.

5. The method of claim 1, wherein the determined closest stored bitmap is a custom bitmap named according to the naming convention, the naming convention associating a name of the custom bitmap and a resolution representation of the custom bitmap to the custom bitmap.

6. The method of claim 1, wherein the determined closest stored bitmap is a bitmap created in an application toolkit named according to the naming convention, the naming convention associating a name of the bitmap created in the application toolkit and a resolution representation of the bitmap created in the application toolkit to the bitmap created in the application toolkit.

7. The method of claim 1, wherein the plurality of stored bitmaps are stored in a user interface component library, the user interface component library being a component library in a development environment for developing a plurality of applications.

8. The method of claim 1, wherein the resolution indication is based on a scaling factor.

9. The method of claim 8, wherein the scaling factor is based on a ratio of one or more pixel densities and a desired one or more pixel densities.

10. A non-transitory processor-readable medium having processor-readable instructions, when executed, cause a processor to:
determine a resolution indication for a resolution of a display device;
determine a closest stored bitmap from a plurality of stored bitmaps according to the resolution indication, wherein each of the plurality of stored bitmaps are named according to a naming convention, the naming convention associating a name of one of the plurality of stored bitmaps and a resolution representation value of the one of the plurality of stored bitmaps to the one of the plurality of stored bitmaps, the plurality of stored bitmaps being components for controls, each of the components for controls including one or more graphical elements; and
display a digital image corresponding to the closest stored bitmap.

11. The non-transitory processor-readable medium having processor-readable instructions of claim 10, wherein the resolution indication is based on a message from an operating system.

12. The non-transitory processor-readable medium having processor-readable instructions of claim 10, wherein the resolution indication is determined based on a user command.

13. The non-transitory processor-readable medium having processor-readable instructions of claim 10, wherein determining the closest stored bitmap comprises:
determining a resolution representation of the resolution indication; and
determining the closest stored bitmap based on the resolution representation of the resolution indication and the plurality of stored bitmaps, the closest stored bitmap determined by comparing the resolution representation of the resolution indication to the resolution representation of each of the plurality of stored bitmaps, and selecting the closest stored bitmap based on a smallest difference between the resolution representation of the one of the plurality of stored bitmaps and the resolution representation of the resolution indication.

14. The non-transitory processor-readable medium having processor-readable instructions of claim 10, wherein the determined closest stored bitmap is a custom bitmap named according to the naming convention, the naming convention associating a name of the custom bitmap and a resolution representation of the custom bitmap to the custom bitmap.

15. The non-transitory processor-readable medium having processor-readable instructions of claim 10, wherein the determined closest stored bitmap is a bitmap created in an application toolkit named according to the naming convention, the naming convention associating a name of the bitmap created in the application toolkit and a resolution representation of the bitmap created in the application toolkit to the bitmap created in the application toolkit.

16. The non-transitory processor-readable medium having processor-readable instructions of claim 10, wherein the plurality of stored bitmaps are stored in a user interface component library, the user interface component library being a component library in a development environment for developing a plurality of applications.

17. The non-transitory processor-readable medium having processor-readable instructions of claim 10, wherein the resolution indication is based on a scaling factor.

18. The non-transitory processor-readable medium having processor-readable instructions of claim 17, wherein the scaling factor is based on a ratio of one or more pixel densities and a desired one or more pixel densities.
